(19) United States
(12) Patent Application Publication
(10) Pub. No.: US 2016/0049087 A1
(43) Pub. Date: Feb. 18, 2016

(54) COMPUTER-BASED METHOD FOR CREATING AND PROVIDING A MUSIC EDUCATION ASSESSMENT

(71) Applicant: MUSIC SALES DIGITAL SERVICES LLC, Chester, NY (US)

(72) Inventor: James Thomas Frankel, Chester, NY (US)

(21) Appl. No.: 14/458,072

(22) Filed: Aug. 12, 2014

(51) Int. Cl. G09B 15/00; G09B 7/02

(52) U.S. Cl. CPC G09B 15/00; G09B 7/02

(57) ABSTRACT

A computer-based method for creating and providing a music education assessment. The computer-based method may comprise the steps of: providing a server; wherein the server may comprises a server application configured to access a machine readable media; wherein the server application may be configured to allow a user to create at least one assessment comprising a plurality of questions; storing on the machine readable media the at least one assessment; establishing a link between the server and a computer system; transmitting to the computer system the at least one assessment; and receiving one or more responses to the at least one assessment from a student; wherein the one or more responses includes at least one response created by a third party software sent by said student.

### FIELD OF USE

The present disclosure relates to methods and systems for providing online assessments and, in particular, to methods and systems for generating assessments, tests, and quizes for music educators that may utilize third party software on a single platform with audio recording functionality.

### BACKGROUND

Various approaches exist for teaching, evaluating, assessing, and measuring a student's competencies for a particular subject. Such assessments may include various questions, such as matching, multiple choice, true/false, fill-sin-the-blank, and essay. Traditionally, these assessments have been offered on paper and have been made available only in person.

With the popularization of web-based classes, however, assessments began being offered via a computerized system. Some known systems and methods for providing test assessments through a computerized system may include tests taken at testing sites and online courses. Computerized assessments generally provide flexibility to students and teachers, as they generally do not need to meet in a classroom in order to take a quiz, assignment, or assessment. Additionally, computerized assessments generally result with shortened turn around response time, such that results and feedback on the assessment are available immediately without delay associated with paper assessments.

Unfortunately, such online classes and courses are generally not practicable or available for music educators and students. In general, creating tests, quizzes, and assessments for music teachers usually require that the educator select each test item independently and manually sequence the test items. The educator may also need to be present for each individual student to provide an in-depth review of the student's abilities. As a result, such testing can be time consuming, labor intensive, and cumbersome. These teaching methods also do not generally provide any mechanism to ensure that the students are learning proper educational material tailored to a specific musical ability. Accordingly, music educators must review the course and test each student individually to ensure proper lessons are presented to each student. Furthermore, testing material produced based on current methods and systems is generally not tailored to a specific student's needs.

Furthermore, most online assessments are directed to subjects unrelated to music education. Most online courses and curriculum are directed to traditional subjects such as English, science, and math and generally do not involve the liberal arts such as music. As a result, these online assessments generally do not incorporate any audio feature in its questions and/or answers.

Thus, a need exists for improved systems and methods for producing and/or delivering assessment questions for music educators. Preferably, these systems and methods will provide educational material customized to accommodate an individual student's needs and preferably work with third party software.

### SUMMARY

To minimize the limitations in the prior art, and to minimize other limitations that will become apparent upon reading and understanding the present specification, the following discloses a new and improved computer-based method for creating and providing a music education assessment.

One embodiment may be a computer-based method for creating and providing a music education assessment, comprising the steps of: providing a server; wherein the server comprises a server application; wherein the server application is configured to allow a user to create at least one music education assessment comprising a plurality of questions; wherein at least one of the plurality of questions is provided by a third party software that is integrated with the server application; storing on a machine readable media of the server the at least one music education assessment; establishing a link between the server and at least one computer system; transmitting to the at least one computer system the at least one music education assessment; and receiving one or more responses to the at least one music education assessment from a student; wherein the one or more responses comprises at least one file attachment and at least one response given by the student to the at least one third party software question. The server application may utilize the third party software to create at least one audio recording question, such that the plurality of questions may further comprise the at least one audio recording question. The server application may be configured to receive at least one audio input from the student in response to the plurality of questions. The server application may be configured to receive at least one audio input from the student in response to the at least one audio recording question. The computer-based method may further comprise the step of: evaluating one or more skills of the student based on the one or more responses to the at least one music education assessment. The computer-based method may further comprise the step of: analyzing the one or more responses to create a report of the student. The computer-based method may further comprise the step of: prompting the student to answer the at least one music education assessment. A question of the plurality of questions may be selected from the group of questions consisting of: a multiple choice question, a true or false question, and a fill-in-the-blank question. The computer-based method may further comprise the step of: prompting the user to create the at least one music education assessment. The computer-based method may further comprise the step of: receiving a notification from the third party software that the student completed the at least one music education assessment.

Another embodiment may be a computer-based method for creating and providing a music education assessment, the method comprising the steps of: providing a server; wherein the server comprises a server application; wherein the server application is configured to allow a user to create at least one music education assessment comprising a plurality of questions; wherein at least one of the plurality of questions is provided by a third party software that is integrated with the server application; wherein the server application utilizes the third party software to create at least one audio recording question, such that the plurality of questions further comprises the at least one audio recording question; storing on a machine readable media of the server the at least one music education assessment; establishing a link between the server and at least one computer system; transmitting to the at least one computer system the at least one music education assessment; receiving one or more responses to the at least one music education assessment from a student; and wherein the one or more responses comprises at least one file attachment and at least one response given by the student to the at least one third party software question. The server application may be configured to receive at least one audio input from the student in response to the plurality of questions. The server application may be configured to receive at least one audio input from the student in response to the at least one audio recording question. The computer-based method may further comprise the step of: evaluating one or more skills of the student based on the one or more responses to the at least one music education assessment. The computer-based method may further comprise the step of: analyzing the one or more responses to create a report of the student. The computer-based method may further comprise the step of: prompting the student to answer the at least one music education assessment. A question of the plurality of questions may be selected from the group of questions consisting of: a multiple choice question, a true or false question, and a fill-in-the-blank question. The server application may communicate with the at least one computer system via a web browser. The computer-based method may further comprise the step of: prompting the user to create the at least one music education assessment; and sending the user to the third party software to create the at least one third party software question.

Another embodiment may be a computer-based method for creating and providing a music education assessment, the method comprising the steps of: providing a server; wherein the server comprises a server application; wherein the server application is configured to allow a user to create at least one music education assessment comprising a plurality of questions; wherein at least one of the plurality of questions is provided by a third party software that is integrated with the server application; wherein the server application utilizes the third party software to create at least one audio recording question, such that the plurality of questions further comprises the at least one audio recording question; wherein the server application is configured to receive an audio input from a student in response to the audio recording question; wherein the server application is configured to receive at least one audio input from the student in response to the at least one audio recording question; prompting the user to create the at least one music education assessment; wherein a question of the plurality of questions is selected from the group of questions consisting of: a multiple choice question, a true or false question, and a fill-in-the-blank question; storing on a machine readable media of the server the at least one music education assessment; establishing a link between the server and at least one computer system; transmitting to the at least one computer system the at least one music education assessment; prompting the student to answer the at least one music education assessment; receiving one or more responses to the at least one music education assessment from the student; wherein the one or more responses comprises at least one file attachment and at least one response given by the student to the at least one third party software question; evaluating one or more skills of the student based on the one or more responses to the at least one music education assessment; and analyzing the one or more responses to create a report of the student.

It is an object to provide a computer-based method for providing an assessment generator specifically designed for music education with unique functionality.

It is another object to provide a computer-based method that generates custom assessments for music educators including various types of data collection and questions, including without limitation, matching, multiple choice, true/false, fill in the blank, free form, and audio recording.

It is another object to provide a computer-based method for generating custom assessments that utilize integrated third party software.

It is an object to provide a computer-based method for utilizing integrated third party software questions for an assessment generator that receives responses or submissions from students, which are reported back to the server application or server platform.

It is an object to provide a computer-based method that utilizes audio recording questions that may be created by third party software (e.g., Soundation™).

It is an object of the new apparatus to avoid the limitations of the prior art.

Other features and advantages that are inherent in the computer-based method claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the computer-based method for creating and providing a music education assessment.

FIG. 2 is a block diagram of one embodiment of a computer system.

FIG. 3 is a flow chart of one embodiment of the system for creating and providing a music education assessment.

FIG. 4 is a flow chart of one embodiment of the computer-based method and shows the workflow for a student submitting a task.

FIG. 5 is a flow chart of one embodiment of the computer-based method and shows the workflow of a teacher grading an assessment.

FIG. 6 is a screenshot of one embodiment of the create assessment window of the computer-based method for creating and providing a music education assessment.

FIG. 7 is a screenshot of one embodiment of the create question window of the computer-based method for creating and providing a music education assessment.

### DETAILED DESCRIPTION OF THE ILLUSTRATIVE EMBODIMENTS

In the following detailed description, numerous specific details are set forth in order to provide a thorough understanding of various aspects of one or more embodiments of the disclosure. However, the one or more embodiments may be practiced without some or all of these specific details. In other instances, well-known methods, procedures, and/or components have not been described in detail so as not to unnecessarily obscure aspects of embodiments.

While multiple embodiments are disclosed, other embodiments may become apparent to those skilled in the art from the following detailed description. As will be realized, the following is capable of modifications in various obvious aspects, all without departing from the spirit and scope of the disclosure. Accordingly, the graphs, figures, and the detailed descriptions thereof, are to be regarded as illustrative in nature and not restrictive. Also, the reference or non-reference to a particular embodiment shall not be interpreted to limit the scope of protection.

Before the following is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment”, “an embodiment”, or “another embodiment” may mean that a particular feature, structure, or characteristic described in connection with the embodiment may be included in at least one embodiment of the present disclosure. Thus, appearances of the phrases “in one embodiment” or “in an embodiment” in various places throughout this specification may not necessarily refer to the same embodiment.

Furthermore, the described features, structures, or characteristics may be combined in any suitable manner in one or more embodiments. In the following description, numerous specific details are provided, such as examples of materials, fasteners, sizes, lengths, widths, shapes, etc., to provide a thorough understanding of the embodiments. One skilled in the relevant art will recognize, however, that the scope of protection can be practiced without one or more of the specific details, or with other methods, components, materials, etc. In other instances, well-known structures, materials, or operations are generally not shown or described in detail to avoid obscuring aspects of the disclosure.

### DEFINITIONS

In the following description, certain terminology is used to describe certain features of one or more embodiments. For example, as used herein, the terms “computer”, “computer system”, “computing device”, “electronic data processing unit”, or “server” generally refer to any device that processes information with an integrated circuit chip, including without limitation, personal computers, mainframe computers, workstations, servers, desktop computers, portable computers, laptop computers, embedded computers, wireless devices, including cellular phones, personal digital assistants, tablets, tablet computers, smart phones, portable game players, and hand-held computers.

As used herein, the term “Internet” generally refers to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the terms “application”, “software”, “server application”, or “software application” generally refer to any set of machine-readable instructions on a client machine, web interface, and/or computer system, that directs a computer's processor to perform specific steps, processes, or operations disclosed herein.

As used herein, the term “machine readable media” may refer to any storage medium configured to store data and/or instructions that are executable by a processor of a computer system. The machine readable media may be a computer-readable non-transitory storage medium and/or any non-transitory data storage circuitry (e.g., buffers, cache, and queues) within transceivers of transitory signals. The machine readable media may also be any tangible computer readable medium. In various embodiments, a machine readable media may also be able to store data which is able to be accessed by the processor of the computer system. Examples of such machine readable media may comprise, without limitation: a floppy disk, a magnetic hard disk drive, a solid state hard disk, flash memory, a USB thumb drive, Random Access Memory (RAM) memory, Read Only Memory (ROM) memory, an optical disk, a magneto-optical disk, and the register file of the processor. Examples of optical disks may include Compact Disks (CD) and Digital Versatile Disks (DVD), for example CD-ROM, CD-RW, CD-R, DVD-ROM, DVD-RW, or DVD-R disks. The term “machine readable media” may also refer to various types of recording media capable of being accessed by the computer device via a network or communication link. For example data may be retrieved over a modem, over the internet, or over a local area network.

As used herein, the terms “prompt” or “prompting” may refer to any act by the application to assist or encourage a user to perform a certain act. The terms “prompt” or “prompting” may also refer to any passive action or inaction by the application that allows or permits a user to perform a certain act without the assistance or act of the application.

As used herein, the terms “music education assessment” and “assessment” may refer to the evaluation or estimation of the nature, quality, or ability of someone's musical abilities, including without limitation, tests, quizzes, exams, valuations, and the like.

The present specification discloses a new and improved computer-based method for creating and providing a music education assessment. The computer-based method may comprise the steps of: providing a server; wherein the server may comprises a server application configured to access a machine readable media; wherein the server application may be configured to allow a user to create at least one assessment comprising a plurality of questions; storing on the machine readable media the at least one assessment; establishing a link between the server and a computer system; transmitting to the computer system the at least one assessment; and receiving one or more responses to the at least one assessment from a student; wherein the one or more responses includes at least one response created by a third party software sent by the student.

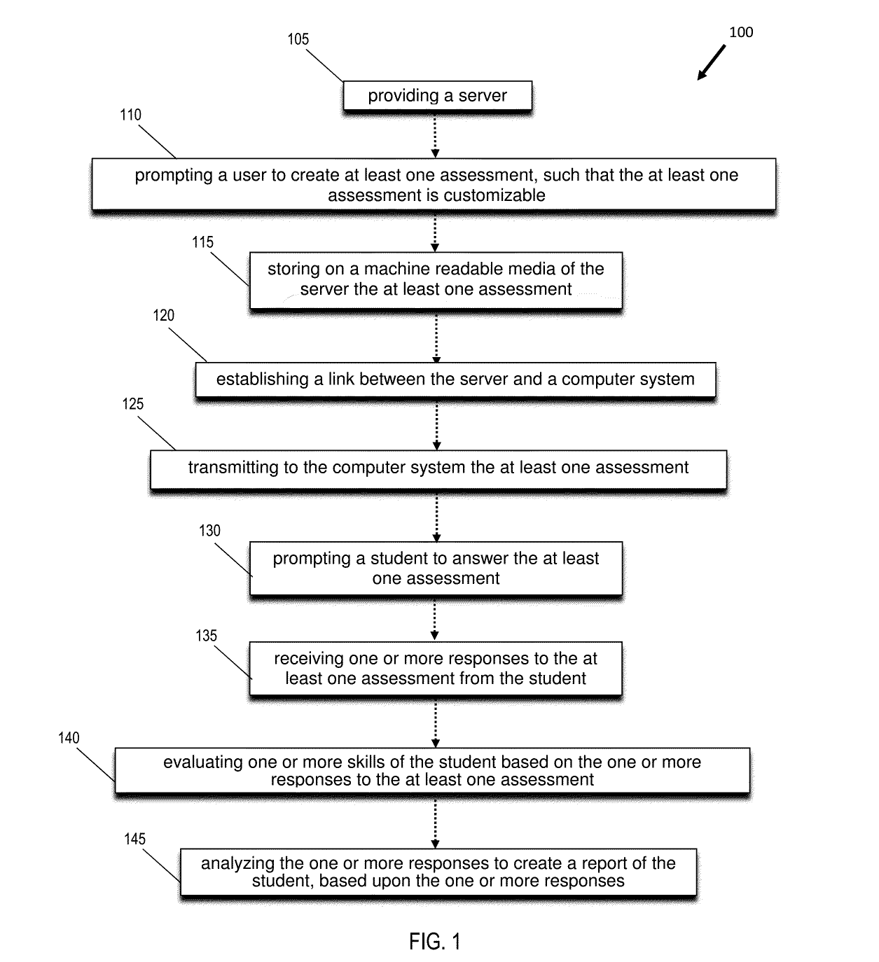

FIG. 1 is a flow chart of one embodiment of the computer-based method for creating and providing a music education assessment. As shown in FIG. 1, one embodiment of the computer-based method 100 may comprise the steps: 105, 110, 115, 120, 125, 130, 135, 140; and 145. FIG. 1 shows the first step of one embodiment of the computer-based method 100, which may be providing a server 105. The server may be any computer system or computer program that manages access to a centralized resource or service in a network of computers. Such resources may include files, websites, and webpages. In one embodiment, the server may manage a set of interconnected webpages, which may include a homepage, and may be prepared and maintained as a collection of copyrighted content (e.g., digital rights content) and user generated content. The server may also comprise a server application adapted to prompt a user to enter his or her login information such as a username and password and may be capable of receiving and sending hypertext transfer protocol (HTTP) requests or a web container that generally provides an environment for servlets and Java Server Pages (JSP) to run. Additionally, the server application may gather browser history, internet protocol (IP) location, and other information from the user, and may provide additional webpages. In a preferred embodiment, the server may host a server application such as a web site in the Internet.

In various embodiments, the server application may be configured to access machine readable media. As discussed above, the server application may be any set of machine-readable instructions that directs a processor to perform specific steps, processes, or operations disclosed herein. Thus, in various embodiments, the server application may be configured to provide an assessment online directed to music education. The server application may also integrate and utilize third party software, which may be a reusable software component developed by programmers or publishers independent other than of the original vendor of the computer-based method disclosed herein. The third party software may also be any software application that generates or creates assessments directed to music education and may include questions involving text, audio, and/or video. An example of a third party software application that may be by the computer-based method 100 may be Soundation™, which preferably utilizes recording, effects, and virtual instruments.

Regarding the machine readable media, the machine readable media may be any device or component used to store data or information. Examples of such machine readable media may include, without limitation: a floppy disk, a magnetic hard disk drive, a solid state hard disk, flash memory, a USB thumb drive, Random Access Memory (RAM) memory, Read Only Memory (ROM) memory, an optical disk, a magneto-optical disk, and the register file of a processor. Examples of optical disks may include, without limitation, Compact Disks (CD) and Digital Versatile Disks (DVD) (e.g., CD-ROM, CD-RW, CD-R, DVD-ROM, DVD-RW, or DVD-R disks). The term “machine readable media” may also refer to various types of recording media capable of being accessed by a computer system via a network or communication link. For example, data may be retrieved over a modem, over the Internet, or over a local area network.

FIG. 1 also shows the next step of an embodiment of the computer-based method 100, which may be prompting a user to create at least one assessment, such that the at least one assessment is customizable 110. As discussed above, the assessments are preferably an evaluation or estimation of the nature, quality, ability, or skills of a student through the use of questions, such as tests, quizzes, exams, valuations, and are preferably directed to music education. In one or more embodiments, the computer-based method 100 may prompt the user, teacher, or music educator to create an assessment, which may involve using the third-party software. The assessment may be customizable by the user and may contain any number of questions. Each question of the assessment may include, without limitation, matching, multiple choice, true/false, fill-in-the-blank, and free form. In various embodiments, the server application may also allow the user to create an audio recording question based on an audio created by the user. The audio recording question may also be configured to receive or accept an audio recording as an answer from a student in response to a question. After the assessment is created, the assessment may be stored on the machine readable media on the server, as shown in the third step of the computer-based method 100—storing on the machine readable media of the server the at least one assessment 115.

FIG. 1 shows the next step of one embodiment of the computer-based method 100, which may be establishing a link between the server and a computer system 120. The computer system may be configured to connect to the server, and this may be accomplished by logging onto the server via a web browser. Specifically, a student may access the server by logging into the server application via the Internet through the use of a computer system such as a desktop, laptop, smartphone, or mobile computing device. The server then may establish a network connection or link with the computer system of the student. As a result, the student may be prompted to complete the assessment that was stored in the machine readable media.

FIG. 1 shows the next two steps of the computer-based method 100, which may be transmitting to the computer system the at least one assessment 125 and prompting the student to answer the at least one assessment 130. Here, after student accesses the server and visits the server application or website, the student may log onto his or her account. In one embodiment, the server application may then transmit the assessment to the student, and the student may be prompted to answer the assessment that was created by the user or music educator. The student may then answer each question in the assessment.

The next step of one embodiment of the computer-based method 100, which may be receiving one or more responses to the at least one assessment from the student 135. After the student answers each question in the assessment, the server application or server may receive the responses from the student. Some responses may also include at least one response created by the third party software sent by the student. Some of the questions created by third party software may then forward the responses of the student and then transfer each response to the server application. Alternatively, in another embodiment, the responses to each question made by the student may be sent directly to the server application and bypass the third party software. Thus, the answers or responses by the student are preferably, ultimately sent to the server application and server.

Once the answers or responses are received by the server or server application, the computer-based method 100 may perform the next step, which may be evaluating one or more skills of the student based on the one or more responses to the at least one assessment 140. The computer-based method 100 may also perform the final of step of analyzing the one or more responses to create a report of the student, based upon the one or more responses 145. Specifically, the server application may evaluate the responses of the student by calculating the score of the assessment. For example, the server application may receive the responses from the student, and based on the calculation of the student's score, the server application may create a report based on the student's answers on the assessment. The report may be based on percentile score or may be based on a curve score (i.e., based upon the scores of other students as well).

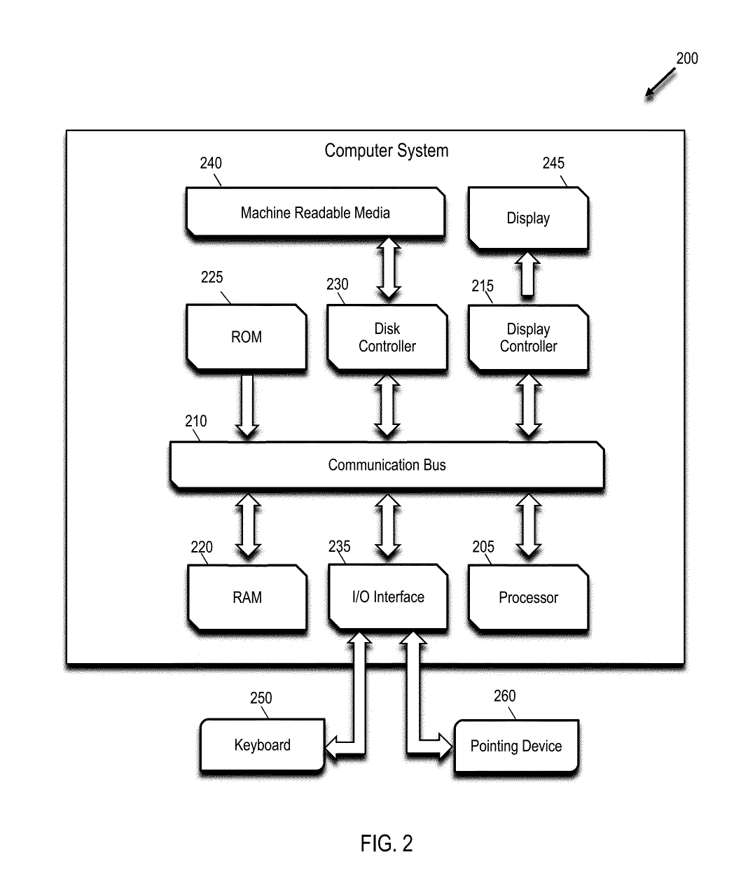

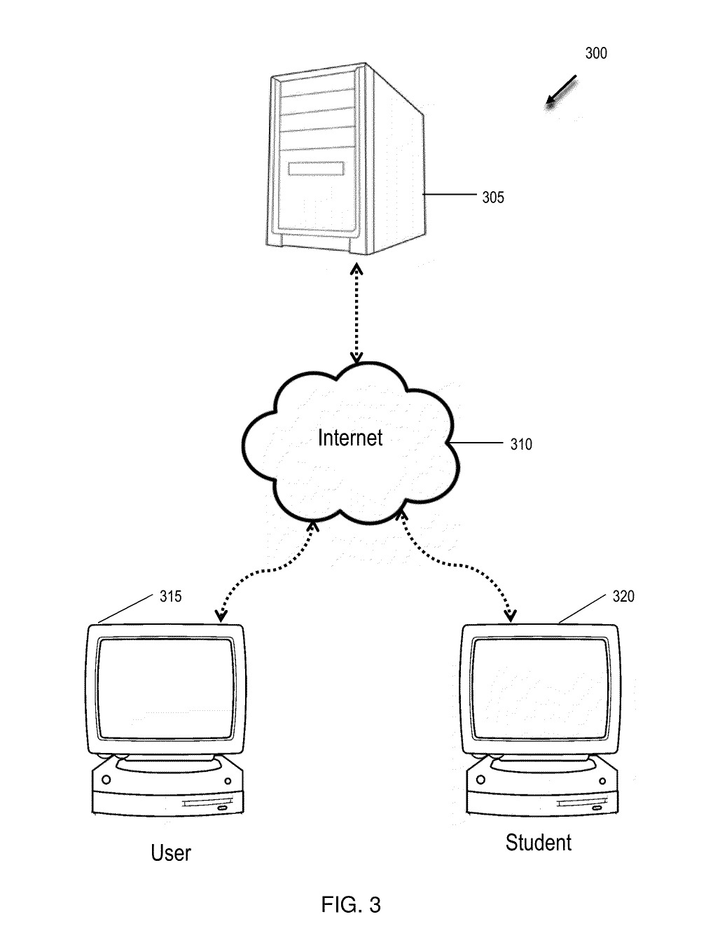

FIG. 2 is a block diagram of one embodiment of a computer system. As shown in FIG. 2, one embodiment of the computer system 200 may comprise: a processor 205, communication bus 210, display controller 215, random access memory (RAM) 220, read only memory (ROM) 225, disk controller 230, input/output interface (I/O interface) 235, machine readable media 240, display 245, and one or more input devices, wherein the input devices may include: a keyboard 250, pointing device 260 (e.g., mouse). In one embodiment, the computer system 200 may be a server or a personal computer that comprises a processor 205 coupled to a communication bus 210. The communication bus 210 may also be coupled to other electronic hardware, including without limitation, a display controller 215, RAM 220, ROM 225, disk controller 230, and I/O interface 235. The disk controller 230 may be used to control the machine readable media 240, which may be a hard drive, solid state drive, and/or optical disk drive. Additionally, the machine readable media 240 may be another form of storage device such as random access memory or flash memory. The display controller 215 may be connected to a display 245 such as a cathode ray tube (CRT), liquid crystal display (LCD), projection system, or touchscreen. The I/O interface 235 may be connected to various input devices such as a keyboard 450, pointing device 260, and/or touchscreen. In additional embodiments, the computer system 400 may also comprise a network controller card connected through a network (shown in FIG. 3) such as the Internet or along an Intranet.

The processor 205 may be used to execute a set of computer readable instructions and further to execute a software application, server application, or computer program such as the server application described herein. The computer readable instructions and server application may comprise instructions that cause the processor 205 to perform the above-disclosed methods and processes when the instructions are executed by the processor 205. In other various embodiments, the computer readable instructions or application may be tangibly embodied in the memory of the computer system 200 such as the RAM 220 or ROM 225, as shown in FIG. 2, or on a machine readable media, such as a magnetic, optical or solid-state digital storage medium.

FIG. 3 is a flow chart of one embodiment of the system for creating and providing a music education assessment. As shown in FIG. 3, one embodiment of the system 300 may comprise: a server 305, Internet 310, and personal computers 315, 320. As discussed above, the server 305 may be a computer system or computer program that manages access to a centralized resource or service in a network and may act as a repository for files, documents, and assessments that may be created by the server application. The Internet 310 may be a computer network consisting of a worldwide network of computer networks that use the TCP/IP network protocols to facilitate data transmission and exchange. The personal computers 315, 320 may be a computer system 200 designed for individual use, such as a music educator or a student at home or school, for completing the assessments.

FIG. 3 also shows how a user may use an embodiment of the system to access the server to complete the assessments of computer-based method 100. Specifically, a user such as a teacher may use his or her computer system 315 (e.g., laptop, desktop, smartphone, tablet computer) and access the server 305 via the Internet 310. This may be accomplished by performing a login on the website of the server 305. Once the user logins the server 305, the user may have access to the server application. The user may then use the server application to create an assessment for music education, which may be used for an online course or online classroom. Once the assessment is completed, the assessment is then preferably stored in the machine readable media of the server 305. A student of the music education course may then use his or her computer system 320 and then access the server 305, typically through the Internet 310. The user may also login the online classroom via the server application and may view the assessment through the display screen of the computer system 320. The user may then answer the questions of the assessment through the computer system 320. The assessment may then be evaluated by the user or instructor, and may then analyze the responses of the student. Although FIG. 3 shows the system 300 with three different devices (e.g., server 305 and computer systems 315, 320), the system 300 may function with any number of devices.

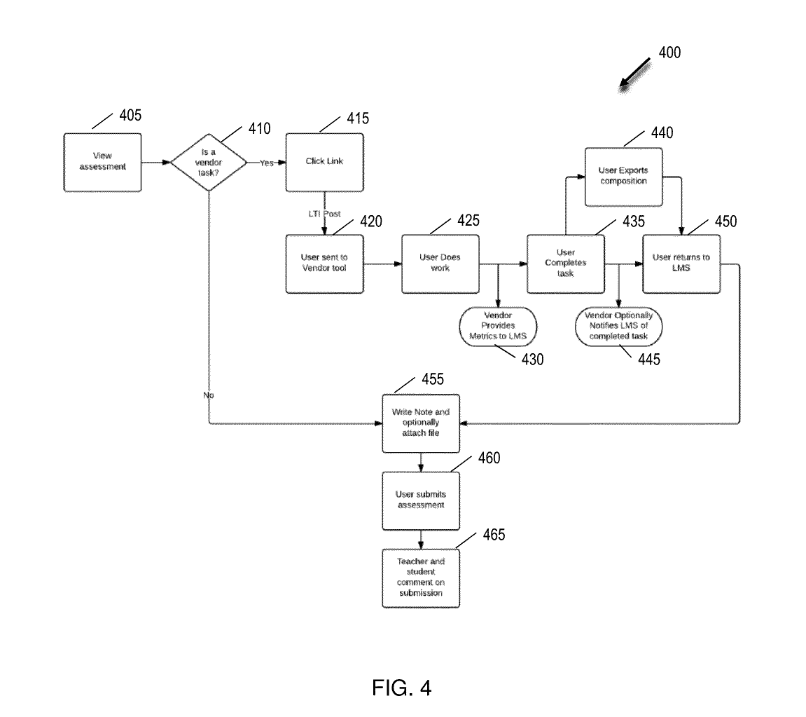

FIG. 4 is a flow chart of one embodiment of the computer-based method and shows the workflow for a student submitting a task. As shown in FIG. 4, one embodiment of the computer-based method 100 may comprise the steps of: 405, 410, 415, 420, 425, 430, 435, 440, 445, and 450. When a student submits a task through the server application, the student may view the assessment 405 through the server application. Depending upon whether the assessment is utilizing third party software, the user may click or visit a link 415, which may direct the student to the third party tool, software or website 420. Upon utilizing the third party software, the student may proceed completing the work or assessment 425, the results of which may be sent back to the server application 430. Upon completion of the assessment 435, the completed work is exported 440, and the third party software may notify the server application about the completed task 445. Thereafter, the student may return to the server application and may complete a white note or musical composition 455. The user may also attach a file along with the white note for submission 460. The user may submit his or her assessment 460 directly to the server application without using the third party software, and the teacher and/or student may comment on the submission.

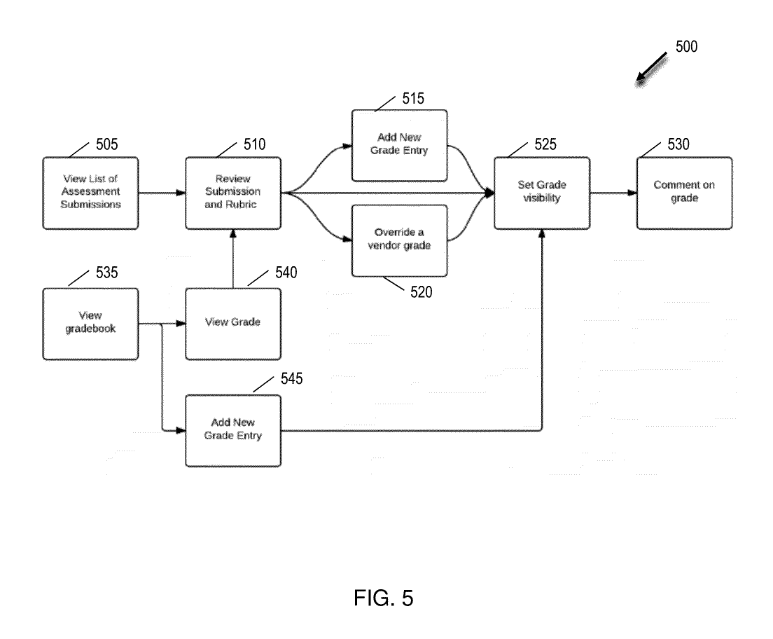

FIG. 5 is a flow chart of one embodiment of the computer-based method and shows the workflow of a teacher grading an assessment. As shown in FIG. 5, one embodiment of the computer-based method 100 may also comprise the steps of: 505, 510, 515, 520, 525, 530, 535, 540, and 545. After a student submits a completed assessment, the teacher may view the list of assessment submissions 505. The teacher may also review the submissions and the rubric (i.e., standard of performance) of each submission 510. When reviewing each submission, the teacher may add a new grade 515 or override an existing grade 520. After reviewing each completed assessment, the teacher may set the grade visible to the student and/or the online classroom 525, such that the grade is visible to the entire online class. Finally, the user or teacher may comment and/or provide suggestions in response to each grade.

In alternative embodiments, the user may also view the gradebook 535, so that he or she may review, edit, and/or finalize each graded assessment. Specifically, the user may view the grade 540 and then review the rubric of each submitted assessment. The user may also add a new grade entry 545, which may be visible to each student and/or online class, and then provide comments/suggestions for the grade entry 550.

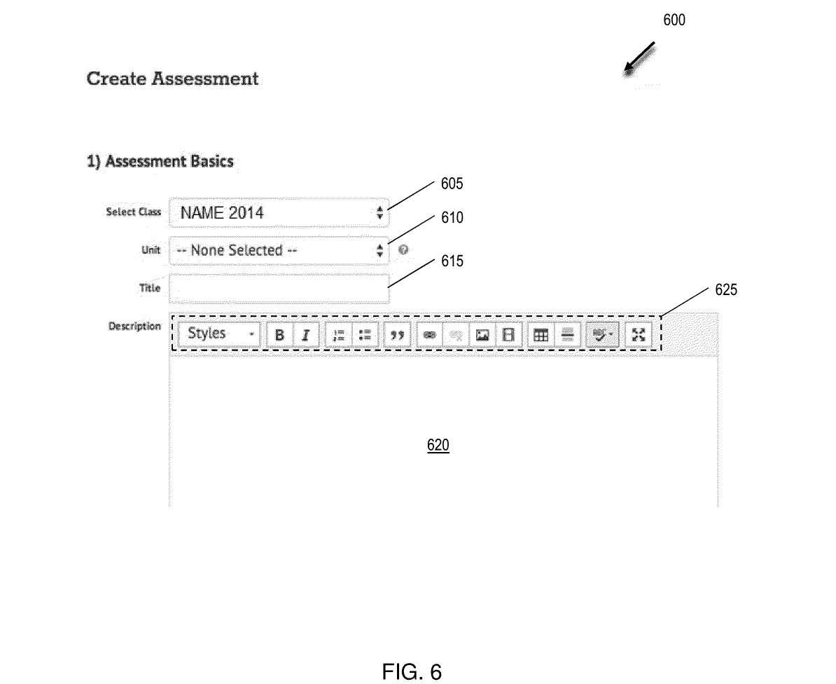

FIG. 6 is a screenshot of one embodiment of the create assessment window of the computer-based method for creating and providing a music education assessment. As shown in FIG. 6, one embodiment of the create assessment window 600 may comprise: a class input field 605, unit input field 610, title input field 615, and description input field 620. The create assessment window 600 may appear when a user or educator decides to create an assessment using the server application. The class input field 605 may be an input field where the user may select the class, course, or online classroom, in which the assessment will be presented to. For example, the user may select class “NAME 2014”, as shown in FIG. 6, as the group of the students who will be taking the assessment. The unit input field 610 may be used to identify which course that the assessment will be used for. In various embodiments, the class input field 605 and unit input field 610 may be a scroll down menu, as shown in FIG. 6, or a typewritten input field. The title input field 610 may be used to create the title of the assessment. The description input field 620 may be used as a template to describe the assessment and may comprise a toolbar to customize the content of the description, including the use of italics, bullet points, color, font style, image and media clips, and the like.

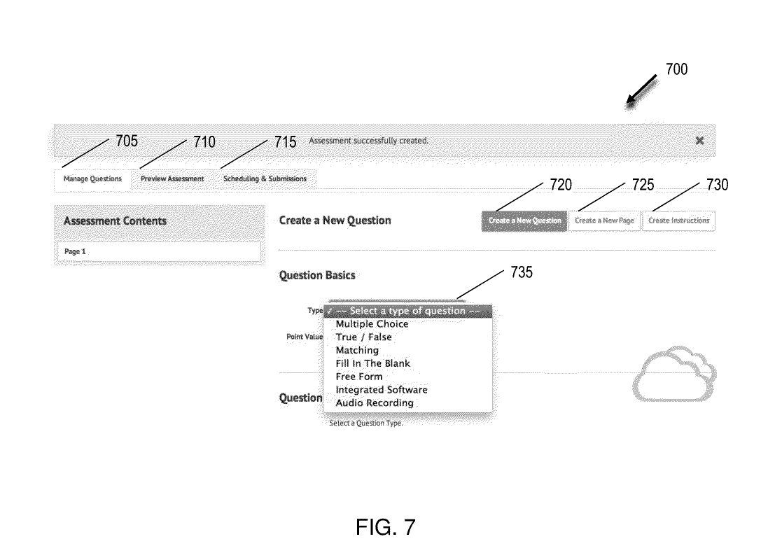

FIG. 7 is a screenshot of one embodiment of the create question window of the computer-based method for creating and providing a music education assessment. As shown in FIG. 7, one embodiment of the create question window 700 may comprise: a manage questions tab 705, preview assessment tab 710, scheduling & submissions tab 715, create new question button 720, create a new page button 725, create instructions button 730, and question type input field 735. The create question window 700 may appear after the user or educator creates an assessment. Specifically, the user may be prompted to manage the questions, preview an assessment, or schedule the assessment, or submit the assessment. These functions and features may be available by either selecting the manage questions tab 705, preview an assessment tab 710, and/or scheduling & submissions tab 715. For instance, when selecting the manage questions tab 705, the user may create questions and select various types of questions. The preview an assessment tab 710 may be used to inspect and view the created assessment before submission. The scheduling & submissions tab 715 may be used to assign and schedule the assignment at a certain time/date. The scheduling & submissions tab 715 may also be used to finalize the questions and assessment.

FIG. 7 also shows the details of how to create a question for the assessment in the create question window 700. Specifically, the user may create a new question by selecting the new question button 720. Upon selecting the new question button 720, the user may be prompted to select a particular question type by using the question type input field 735. As shown in FIG. 7, such question types may include, without limitation, multiple choice, true/false, matching, fill-in-the-blank, free form, integrated software, and audio recording. The multiple choice question generally provides the user multiple answers for the student to select. The true/false question generally asks the student to confirm whether the statement is true or false. The matching question generally prompts the student to mix and match certain question with certain answers. The fill-in-the-blank question generally prompts the student to input and type the correct answer into the blank space provided. The free form question may be an essay type question. The integrated software question generally uses third party software to provide additional effects such as the use of musical instruments, sound effects, and the like. The audio recording question generally prompts the student to use a microphone so that the server application may record the audio input of the student. In an alternative embodiment, the audio recording question may also be used to allow a teacher to make a recording for the student to listen and answer on an assessment. Once the type of question is selected, the user or music educator may then design the question in more detail and/or later provide additional details of that the question. The create new page button 725 may be used to create a new assessment page with one or more new questions, such that the questions may be grouped in a single page. The create instructions button 730 may be used to create instructions as to how to answer the questions and complete the assessment. The create question window 700 may also include other buttons, features, and input fields as well without deviating the scope of this disclosure.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. This disclosure should therefore not be limited by the above described embodiment, method, and examples, but by all embodiments and methods within the scope and spirit of the disclosure as claimed.

The foregoing description of the preferred embodiment has been presented for the purposes of illustration and description. While multiple embodiments are disclosed, still other embodiments will become apparent to those skilled in the art from the above detailed description, which shows and describes illustrative embodiments. As will be realized, the embodiments are capable of modifications in various obvious aspects, all without departing from the spirit and scope. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope. It is intended that the scope not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-based method for creating and providing a music education assessment, comprising the steps of:
providing a server;
wherein said server comprises a server application;
wherein said server application is configured to allow a user to create at least one music education assessment comprising a plurality of questions;
wherein at least one of said plurality of questions is provided by a third party software that is integrated with said server application;
storing on a machine readable media of said server said at least one music education assessment;
establishing a link between said server and at least one computer system;
transmitting to said at least one computer system said at least one music education assessment; and
receiving one or more responses to said at least one music education assessment from a student;
wherein said one or more responses comprises at least one file attachment and at least one response given by said student to said at least one third party software question.

2. The computer-based method of claim 1, wherein said server application utilizes said third party software to create at least one audio recording question, such that said plurality of questions further comprises said at least one audio recording question.

3. The computer-based method of claim 2, wherein said server application is configured to receive at least one audio input from said student in response to said plurality of questions.

4. The computer-based method of claim 2, wherein said server application is configured to receive at least one audio input from said student in response to said at least one audio recording question.

5. The computer-based method of claim 1, further comprising the step of:
evaluating one or more skills of said student based on said one or more responses to said at least one music education assessment.

6. The computer-based method of claim 1, further comprising the step of:
analyzing said one or more responses to create a report of said student.

7. The computer-based method of claim 1, further comprising the step of:
prompting said student to answer said at least one music education assessment.

8. The computer-based method of claim 1, wherein a question of said plurality of questions is selected from the group of questions consisting of: a multiple choice question, a true or false question, and a fill-in-the-blank question.

9. The computer-based method of claim 1, further comprising the step of:
prompting said user to create said at least one music education assessment.

10. The computer-based method of claim 1, further comprising the step of:
receiving a notification from said third party software that said student completed said at least one music education assessment.

11. A computer-based method for creating and providing a music education assessment, the method comprising the steps of:
providing a server;
wherein said server comprises a server application;
wherein said server application is configured to allow a user to create at least one music education assessment comprising a plurality of questions;
wherein at least one of said plurality of questions is provided by a third party software that is integrated with said server application;
wherein said server application utilizes said third party software to create at least one audio recording question, such that said plurality of questions further comprises said at least one audio recording question;
storing on a machine readable media of said server said at least one music education assessment;
establishing a link between said server and at least one computer system;
transmitting to said at least one computer system said at least one music education assessment;
receiving one or more responses to said at least one music education assessment from a student; and
wherein said one or more responses comprises at least one file attachment and at least one response given by said student to said at least one third party software question.

12. The computer-based method of claim 11, wherein said server application is configured to receive at least one audio input from said student in response to said plurality of questions.

13. The computer-based method of claim 11, wherein said server application is configured to receive at least one audio input from said student in response to said at least one audio recording question.

14. The computer-based method of claim 11, further comprising the step of:
evaluating one or more skills of said student based on said one or more responses to said at least one music education assessment.

15. The computer-based method of claim 11, further comprising the step of:
analyzing said one or more responses to create a report of said student.

16. The computer-based method of claim 11, further comprising the step of:
prompting said student to answer said at least one music education assessment.

17. The computer-based method of claim 11, wherein a question of said plurality of questions is selected from the group of questions consisting of: a multiple choice question, a true or false question, and a fill-in-the-blank question.

18. The computer-based method of claim 11, wherein said server application communicates with said at least one computer system via a web browser.

19. The computer-based method of claim 11, further comprising the step of:
prompting said user to create said at least one music education assessment; and
sending said user to said third party software to create said at least one third party software question.

20. A computer-based method for creating and providing a music education assessment, the method comprising the steps of:
providing a server;
wherein said server comprises a server application;
wherein said server application is configured to allow a user to create at least one music education assessment comprising a plurality of questions;
wherein at least one of said plurality of questions is provided by a third party software that is integrated with said server application;
wherein said server application utilizes said third party software to create at least one audio recording question, such that said plurality of questions further comprises said at least one audio recording question;
wherein said server application is configured to receive an audio input from a student in response to said audio recording question;
wherein said server application is configured to receive at least one audio input from said student in response to said at least one audio recording question;
prompting said user to create said at least one music education assessment;
wherein a question of said plurality of questions is selected from the group of questions consisting of: a multiple choice question, a true or false question, and a fill-in-the-blank question;
storing on a machine readable media of said server said at least one music education assessment;
establishing a link between said server and at least one computer system;
transmitting to said at least one computer system said at least one music education assessment;
prompting said student to answer said at least one music education assessment;
receiving one or more responses to said at least one music education assessment from said student;
wherein said one or more responses comprises at least one file attachment and at least one response given by said student to said at least one third party software question;
evaluating one or more skills of said student based on said one or more responses to said at least one music education assessment; and
analyzing said one or more responses to create a report of said student.
